(19) United States
(12) Patent Application Publication
(10) Pub. No.: US 2024/0416759 A1
(43) Pub. Date: Dec. 19, 2024

(54) ELECTRIFIED VEHICLE AND REGENERATIVE BRAKING CONTROL METHOD FOR SAME

(71) Applicants: Hyundai Motor Company, Seoul (KR); Kia Corporation, Seoul (KR)

(72) Inventor: Kyu Beom KO, Hwaseong-si (KR)

(21) Appl. No.: 18/504,552

(22) Filed: Nov. 8, 2023

(30) Foreign Application Priority Data
Jun. 19, 2023 (KR) 10-2023-0078086

(51) Int. Cl. B60L 7/26

(52) U.S. Cl. CPC B60L 7/26; B60L 2240/423

(57) ABSTRACT

Provided are an electrified vehicle and a regenerative braking control method for the same. A first motor is connected to a first drive wheel depending on an engagement state of a disconnector. A second motor is connected to the first drive wheel. A controller controls the engagement state of the disconnector on the basis of required braking force before regenerative braking force generated by means of the second motor reaches an upper limit during regenerative braking by means of the second motor and controls regenerative braking force of the first motor and the second motor on the basis of the engagement state of the disconnector.

### CROSS-REFERENCE TO RELATED APPLICATION

The present application claims priority of Korean Patent Application No. 10-2023-0078086 filed on Jun. 19, 2023, the entire contents of which are incorporated herein for all purposes by this reference.

### TECHNICAL FIELD

The present disclosure relates to an electrified vehicle and a regenerative braking control method for the same that improves efficiency of regenerative braking when substantial braking force is necessary.

### BACKGROUND

Given the growing concern for the environment, there has been a notable surge in the popularity of eco-friendly vehicles including an electric motor as their primary power source. These eco-friendly vehicles fall under the category of electrified vehicles, with a hybrid electric vehicle (HEV) and an electric vehicle (EV) serving as notable representatives.

A motor provided in such an electrified vehicle may charge a battery using the driving force of wheels from wheel deceleration. This process is commonly known as braking energy regeneration or regenerative braking. More specifically, when braking is required, entire braking force or torque according to the braking requirement is calculated, and then regenerative braking may be performed using the motor within the entire braking force. In this case, a shortage obtained by subtracting regenerative braking force generated by means of the entire braking force may be processed by hydraulic braking.

In addition, an electrified vehicle may be provided with a plurality of motors, with some serving as primary driving sources and others as supplementary driving sources. In such a scenario, the preference is to prioritize regenerative braking through the motors designated as the main driving sources.

Under typical operating conditions, prioritizing regenerative braking through specific motors designated as the main driving sources, as described above, can improve overall efficiency. However, when a substantial braking force is needed, such as during abrupt brake pedal application by the driver, relying solely on the main driving source motors may be insufficient. In this case, the possibility of hydraulic force intervention becomes more probable.

Accordingly, there is a demand for a solution capable of reducing reliance on hydraulic force intervention and optimizing regenerative braking through the effective utilization of a plurality of motors.

### SUMMARY

The present disclosure is directed to an electrified vehicle and a regenerative braking control method that improves efficiency of regenerative braking when substantial braking force is necessary.

For example, the present disclosure is directed to an electrified vehicle and a regenerative braking control method for the same that reduces hydraulic pressure intervention through the effective utilization of a plurality of motors when a substantial braking force is needed.

According to one aspect, an electrified vehicle can include: a first motor connected to a first drive wheel depending on an engagement state of a disconnector; a second motor connected to the first drive wheel; and a controller configured to control the engagement state of the disconnector on the basis of required braking force before regenerative braking force generated by means of the second motor reaches an upper limit during regenerative braking by means of the second motor and control regenerative braking force of the first motor and the second motor on the basis of the engagement state of the disconnector.

The controller may control the engagement state of the disconnector irrespective of the regenerative braking force generated by means of the second motor.

When the required braking force is greater than the upper limit of the regenerative braking force by the second motor, the controller may control the disconnector to be engaged.

When an increase per time of the required braking force is greater than a predetermined value, the controller may control the disconnector to be engaged.

When the disconnector is engaged, the controller may distribute the required braking force to the first motor and the second motor. The required braking force may be preferentially distributed to the second motor so that the regenerative braking force generated by means of the second motor reaches the upper limit.

After the disconnector is engaged, the controller may perform control so that the required braking force greater than the regenerative braking force generated by means of the first motor and the second motor is met by hydraulic braking.

The second motor may be constantly connected to the second drive wheel.

According to another aspect, a regenerative braking control method of an electrified vehicle including a first drive wheel connected to a first motor depending on an engagement state of a disconnector and a second drive wheel connected to a second motor can include: during regenerative braking by means of the second motor, controlling the engagement state of the disconnector on the basis of required braking force; and controlling regenerative braking force generated by the first motor and the second motor on the basis of the engagement state of the disconnector.

The controlling of the engagement state of the disconnector may be performed on the basis of the required braking force irrespective of whether an upper limit of the regenerative braking force generated by means of the second motor is reached or not.

In the controlling of the engagement state of the disconnector, when the required braking force is greater than the upper limit of the regenerative braking force generated by means of the second motor, the disconnector may be controlled to be engaged.

In the controlling of the engagement state of the disconnector, when an increase per time of the required braking force is greater than a predetermined value, the disconnector may be controlled to be engaged.

In the controlling of the engagement state of the disconnector, after the disconnector is engaged, the required braking force may be distributed to the first motor and the second motor. The required braking force may be preferentially distributed to the second motor so that the regenerative braking force generated by means of the second motor reaches the upper limit.

The method may further include, after the disconnector is engaged, performing control so that the required braking force greater than the regenerative braking force generated by means of the first motor and the second motor is met by hydraulic braking.

The second motor may be constantly connected to the second drive wheel.

According to a variety of implementations of the present disclosure, regenerative braking may be more efficiency performed by previously controlling a driving method of a vehicle by means of a plurality of motors on the basis of required braking force.

In particular, in a situation in which a large amount of braking force is required, the possibility of intervention of hydraulic pressure can be reduced by increasing a total amount of braking force. As a result, a fuel efficiency can be improved, and damages such as wear in the brake pad occurring during a braking process can be reduced.

It will be appreciated by those skilled in the art that the effects that can be achieved with the present disclosure are not limited to those described above and other advantages of the present disclosure will be clearly understood from the following detailed description.

### BRIEF DESCRIPTION OF THE DRAWINGS

FIG. 1 is a diagram illustrating an example of a driving method of an electrified vehicle.

FIG. 2 is a block diagram illustrating an example of a controller of the electrified vehicle.

FIGS. 3A and 3B are graphs illustrating an example of a control logic of an electrified vehicle.

FIG. 4 is a flowchart illustrating an example of a regenerative braking control process of an electrified vehicle.

### DETAILED DESCRIPTION

A term such as “unit” or “control unit” included in the names of some elements, such as a motor control unit (MCU) and a hybrid control unit (HCU), is only a term widely used in naming of a controller that controls a specific function of a vehicle but should not be understood as indicating a generic function unit.

In addition, a term “controller” may include a communication device communicating with another controller or a sensor in order to control a function which the controller manages, a memory storing an operating system, logic instructions, input/output information, and the like, and one or more processors performing determination, calculation, decision, and the like necessary for controlling the function.

An electrified vehicle and a regenerative braking control method for the same are proposed to efficiently perform regenerative braking by controlling the driving of a vehicle using a plurality of motors on the basis of required braking force.

Here, vehicle driving methods using a plurality of motors may be classified as a two-wheel drive (2WD) method in which driving force of the motors is transferred to only one pair of wheels among the front wheels and the rear wheels and a four-wheel drive (4WD) method in which driving force of the motors is transferred to both the front wheels and the rear wheels.

In addition, it will be assumed that the electrified vehicle can convert between the 2WD method and the 4WD method in order to effectively perform regenerative braking by controlling the driving method.

In addition, in a case in which the electrified vehicle is driven by the 2WD method, one pair of wheels to which the drive force of the motors is transferred may be referred to as main drive wheels, while the other pair of wheels to which the drive force of the motors is transferred only when the electrified vehicle is driven by the 4WD method may be referred to as auxiliary drive wheels. For example, the main drive wheels may be the rear wheels and the auxiliary drive wheels may be the front wheels, but the present disclosure is not limited thereto. Rather, the main drive wheels and the auxiliary drive wheels may be determined in the opposite manner.

Prior to describing the regenerative braking control method, the electrified vehicle will be described first as follows.

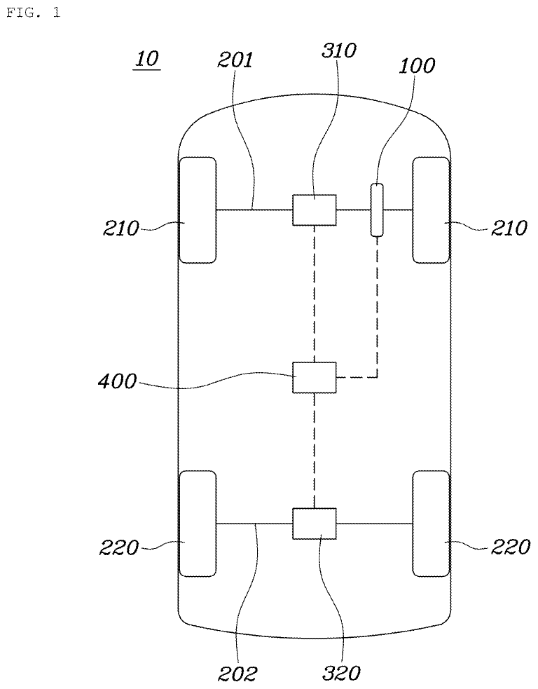

FIG. 1 is a conceptual diagram illustrating a driving method of an electrified vehicle.

Referring to FIG. 1, an electrified vehicle 10 can include a disconnector 100, first drive wheels 210, second drive wheels 220, a first motor 310, and a second motor 320. The disconnector 100, the first motor 310, and the second motor 320 may be connected to a controller 400 to be described below. FIG. 1 mainly illustrates components of the present disclosure, and the electrified vehicle 10 may actually include a greater or smaller number of components. Hereinafter, respective components will be described in detail.

First, the first motor 310 may be connected to the first drive wheels 210 depending on the engagement state of the disconnector 100. When the first motor 310 and the first drive wheels 210 are connected, drive force from the first motor 310 may be transferred to the first drive wheels 210.

In addition, the second motor 320 may be connected to the second drive wheels 220 to supply driving force to the second drive wheels 220. The second motor 320 and the second drive wheels 220 may be connected through a second drive shaft 202.

The disconnector 100 may connect or disconnect the first drive wheels 210 and the first motor 310 depending on the engagement state. More specifically, when the disconnector 100 is engaged, the first drive wheels 210 and the first motor 310 may be connected to each other so that the driving force of the first motor 310 may be transferred to the first drive wheels 210. When the disconnector 100 is engaged, the first drive wheels 210 and the first motor 310 may be disconnected so that the driving force of the first motor 310 is not transferred to the first drive wheels 210.

In order to control the connection or disconnection between the first drive wheels 210 and the first motor 310, the disconnector 100 may be disposed on the first drive wheel 210 side. More specifically, the disconnector 100 may be attached to a reducer on a first drive shaft 201. The disconnector 100 may control the first motor 310 to be connected to or disconnected from the first drive wheels 210 connected to the first drive shaft 201 by connecting or disconnecting the first motor 310 and the first drive shaft 201.

The second motor 320 and the second drive wheels 220 may be constantly connected unlike the first motor 310 and the first drive wheels 210. Thus, the disconnector 100 may not be provided on the second drive wheel 220 side.

In this manner, the driving method of the vehicle may be converted from 2WD to 4WD or from 4WD to 2WD by controlling the engagement state of the disconnector 100 that determines the first drive wheels 210 and the first motor 310 to be connected or disconnected.

In addition, the second drive wheels 220 are constantly connected to the second motor 320 to receive the driving force even in 2WD, and thus may be referred to as the main drive wheels. The first drive wheels 210 are connected to the first motor 310 by means of the disconnector 100 to receive the driving force in 4WD, and thus may be referred to as the auxiliary drive wheels.

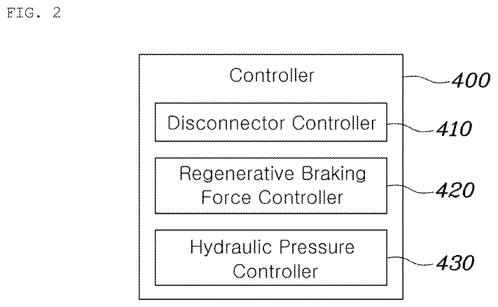

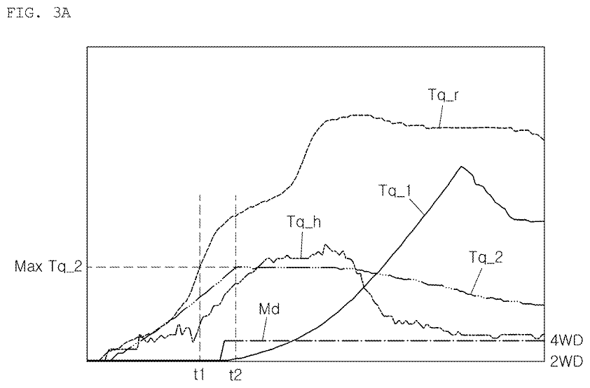

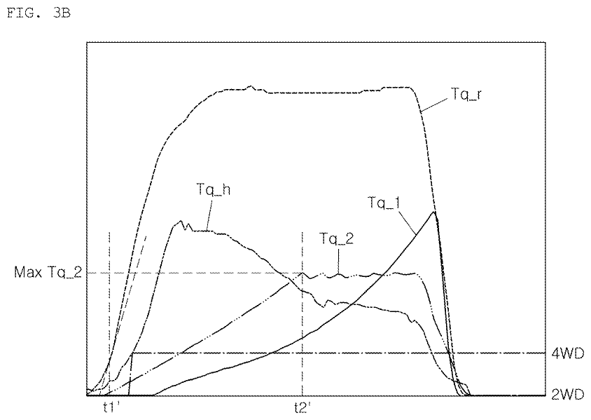

On the other hand, the electrified vehicle 10 can be provided with the controller 400 to control the disconnector 100, the first motor 310, and the second motor 320 as described above. The controller 400 will be described in detail below with reference to FIGS. 2 to 3B.

FIG. 2 is a block diagram illustrating the configuration of the controller of the electrified vehicle.

Referring to FIG. 2, the controller 400 can include a disconnector controller 410, a regenerative braking force controller 420, and a hydraulic pressure controller 430. FIG. 2 mainly illustrates components related to description of an implementation of the present disclosure, and the controller 400 may actually include a greater or smaller number of components. Hereinafter, respective components of the controller 400 will be described in detail.

First, during regenerative braking by means of the second motor 320, the disconnector controller 410 may control the engagement state of the disconnector 100 on the basis of required braking force before regenerative braking force generated by means of the second motor 320 reaches an upper limit.

In this case, the upper limit of the regenerative braking force generated by means of the second motor 320 may be predetermined or be obtained from a braking controller, a higher-level controller, or the like provided in the vehicle. In addition, the required braking force may be determined depending on the amount of depression of the brake pedal. The required braking force may be determined by receiving measurement results from a brake pedal sensor or the like or be obtained from the braking controller or the higher-level controller or the like.

In particular, the disconnector controller 410 may control the engagement state of the disconnector 100 irrespective of the regenerative braking force generated by means of the second motor 320. That is, when the required braking force meets a predetermined condition, the disconnector controller 410 controls the engagement state of the disconnector 100. In this case, whether the disconnector 100 is engaged or not may be determined irrespective of the regenerative braking force generated by means of the second motor 320.

The disconnector controller 410 controls the engagement state of the disconnector 100 before the regenerative braking force generated by means of the second motor 320 reaches the upper limit. Thus, before intervention of hydraulic force, the vehicle driving method by means of the plurality of motors 310 and 320 may be previously converted and be prepared so that regenerative braking may be efficiently performed.

In addition, the regenerative braking force controller 420 may control the regenerative braking force of the first motor 310 and the second motor 320 on the basis of the engagement state of the disconnector 100.

More specifically, when the disconnector 100 is engaged, the regenerative braking force controller 420 may distribute the required braking force to the first motor 310 and the second motor 320. In this case, the required braking force may be preferentially distributed to the second motor 320 so that the regenerative braking force generated by means of the second motor 320 reaches the upper limit. In particular, when the second drive wheels 220 connected to the second motor 320 are the main drive wheels, the efficiency of regenerative braking may be improved by preferentially distributing the required braking force to the second motor 320.

After the disconnector 100 is engaged, the hydraulic pressure controller 430 may perform control so that the required braking force exceeding the regenerative braking force generated by means of the first motor 310 and the second motor 320 may be met by hydraulic braking.

That is, in the engagement state of the disconnector 100, a total of the regenerative braking force generated by means of the first motor 310, the regenerative braking force generated by means of the second motor 320, and hydraulic braking force is the same as the required braking force. The regenerative braking can be controlled so that the hydraulic braking force is minimized. The regenerative braking may also be controlled so that the regenerative braking force generated by means of the motor connected to the main drive wheels (e.g., the second motor 320) as described above is maximized while the hydraulic braking force is minimized.

In addition, a driving method and a specific regenerative braking control method will be described in more detail with reference to FIGS. 3A and 3B.

FIGS. 3A and 3B are graphs illustrating a control logic of an electrified vehicle.

FIGS. 3A and 3B may be understood as graphs each having times on the horizontal axis and torque or control signals on the vertical axis.

First, referring to FIG. 3A, when required braking force Tq_r is greater than the upper limit Max Tq_2 of regenerative braking force Tq_2 generated by means of the second motor 320, the disconnector controller 410 may control the disconnector 100 to be engaged.

More specifically, at a time point t1 at which the required braking force Tq_r is greater than the upper limit Max Tq_2 of the regenerative braking force Tq_2 generated by means of the second motor 320, the disconnector controller 410 may generate an engagement request that the disconnector 100 be engaged. The disconnector 100 is engaged in response to the engagement request, and before a time point t2′ at which the regenerative braking force Tq_2 generated by means of the second motor 320 reaches the upper limit Max Tq_2, the driving method Md of the vehicle may be converted from the 2WD method to the 4WD method.

Next, with reference to FIG. 3B, when the increase per time of the required braking force Tq_r is greater than a predetermined value, the disconnector controller 410 may control the disconnector 100 to be engaged.

More specifically, the disconnector controller 410 may generate the engagement request that the disconnector 100 be engaged at a time point t′ at which the increase per time of the required braking force Tq_r is greater than the predetermined value. The disconnector is engaged in response to the engagement request, and before a time point t2′ at which the regenerative braking force Tq_2 generated by means of the second motor 320 reaches the upper limit Max Tq_2, the driving method Md of the vehicle may be converted from the 2WD method to the 4WD method.

Referring to both FIGS. 3A and 3B, when the driving method Md of the vehicle is the 2WD method, the regenerative braking force controller 420 may perform control so that the regenerative braking force Tq_2 generated by means of the second motor 320 is as close as possible to the required braking force Tq_r. Here, when the regenerative braking force Tq_2 generated by means of the second motor 320 is insufficient to cover the entire required braking force Tq_r, the hydraulic pressure controller 430 may perform control so that the hydraulic braking force Tq_h is the same as an excess of the required braking force Tq_r.

When the driving method Md of the vehicle is the 4WD method, the regenerative braking force controller 420 may perform control so that the regenerative braking force Tq_1 generated by means of the first motor 310 and the regenerative braking force Tq_2 generated by means of the second motor 320 are as close as possible to the required braking force Tq_r. Also in this case, the excess of the required braking force Tq_r may be met by the hydraulic braking force Tq_h. In addition, the regenerative braking force controller 420 may control the regenerative braking force Tq_1 generated by means of the first motor 310 and the regenerative braking force Tq_2 generated by means of the second motor 320 by distributing the required braking force Tq_r to the first motor 310 and the second motor 320 so that the regenerative braking force Tq_1 generated by means of the first motor 310 reaches the upper limit.

In addition, when the engagement state of the disconnector 100 is controlled on the basis of the regenerative braking force Tq_2 generated by means of the second motor 320, the disconnector 100 may be engaged after the regenerative braking force Tq_2 generated by means of the second motor 320 actually reaches the upper limit Max Tq_2. In this case, regenerative braking by means of the first motor 310 cannot be performed until the driving method Md is converted to the 4WD method, and the hydraulic braking force Tq_h increases in order to cope with the required braking force Tq_r greater than the upper limit Max Tq_2 of the regenerative braking force Tq_2 generated by means of the second motor 320.

In contrast, according to the control according to an implementation of the present disclosure, the engagement request time points t1 and t1′ of the disconnector 100 may precede the time points t2 and t2′ at which the regenerative braking force Tq_2 generated by means of the second motor 320 actually reaches the upper limit Max Tq_2. Thus, as soon as the upper limit Max Tq_2 of the regenerative braking force Tq_2 generated by means of the second motor 320 is reached, the first motor 310 may intervene in regenerative braking, and a portion of the required braking force Tq_r exceeding the upper limit Max Tq_2 of the regenerative braking force Tq_2 generated by means of the second motor 320 may be met by the regenerative braking force Tq_1 generated by means of the first motor 310, thereby reducing the hydraulic braking force Tq_h.

Hereinafter, a control process of above-described regenerative braking will be described with reference to a flowchart.

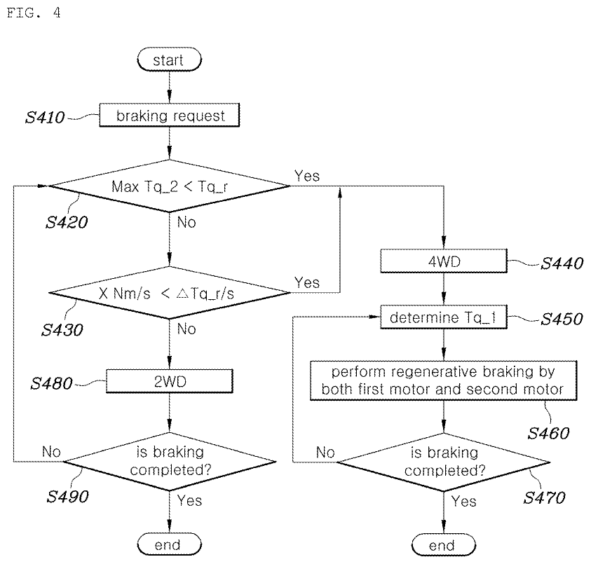

FIG. 4 is a flowchart illustrating a regenerative braking control process of an electrified vehicle.

Referring to FIG. 4, when a braking request is generated in S410, the disconnector controller 410 may compare the required braking force Tq_r and the upper limit Max Tq_2 of the regenerative braking force Tq_2 generated by means of the second motor 320 in S420.

When the required braking force Tq_r is greater than the upper limit Max Tq_2 of the regenerative braking force Tq_2 generated by means of the second motor 320 (YES in S420), the disconnector controller 410 may determine regenerative braking by means of the first motor 310 is necessary and control the disconnector 100 to be engaged so as to convert the driving method of the vehicle to 4WD in S440.

In the 4WD state, the regenerative braking force controller 420 may distribute the required braking force Tq_r to the first motor 310 and the second motor 320. In this regard, the regenerative braking force controller 420 may determine the regenerative braking force Tq_1 of the first motor 310 in S450.

For example, the regenerative braking force controller 420 may determine the regenerative braking force, by which the regenerative braking force Tq_2 generated by means of the second motor 320 reaches the upper limit, to be the regenerative braking force Tq_1 generated by means of the first motor 310. In this case, the value of the regenerative braking force Tq_2 generated by means of the second motor 320 may be greater than that of the regenerative braking force Tq_1 generated by means of the first motor 310.

The first motor 310 and the second motor 320 perform regenerative braking in response to the distribution of the required braking force Tq_r in S460.

In this case, when braking is not completed (NO in S470), the regenerative braking force Tq_1 generated by means of the first motor 310 is continuously determined in response to changes in the required braking force Tq_r (to S450). When braking is completed (YES in S470), the regenerative braking control process is finished.

In addition, differently, even in a case in which the required braking force Tq_r is not greater than the upper limit Max Tq_2 of the regenerative braking force Tq_2 generated by means of the second motor 320 (NO in S420), when a change per time ΔTq_r/s of the required braking force is greater than a predetermined value X in S430, the disconnector controller 410 may control the disconnector 100 to be engaged so as to convert the driving method of the vehicle to the 4WD method in S440.

When the disconnector engagement condition is not met (NO in S430), i.e., when regenerative braking by means of the first motor 310 is determined to not be necessary, the disconnector 100 may be controlled to not be engaged and regenerative braking may be performed by means of the second motor 320 by controlling the electrified vehicle 10 to maintain the 2WD state in S480. In this case, when braking is not completed (NO in S490), whether or not to control the disconnector 100 to be engaged is determined (to S420). When braking is completed (YES in S490), the regenerative braking control process is finished.

According to the variety of implementations of the present disclosure as described above, regenerative braking may be more efficiently performed by previously controlling the vehicle driving method by means of a plurality of motors on the basis of required braking force.

In particular, in a situation in which a large amount of braking force is required, the possibility of intervention of hydraulic pressure can be reduced so as to improve a fuel efficiency. In addition, damages such as wear in the brake pad occurring during the braking process can be reduced.

In addition, the present disclosure as described above may be implemented as computer-readable codes in a program recorded medium. The computer-readable media may include all types of recording devices in which data readable by a computer system is stored. Examples of the computer-readable media include hard disk drives (HDDs), solid state disks (SSDs), silicon disk drives (SDDs), read-only memory (ROM), random access memory (RAM), compact disc read-only memory (CD-ROM), magnetic tape, floppy disks, optical data storage devices, and the like.

What is claimed is:

1. An electrified vehicle comprising:
a first motor configured to be connected to a first drive wheel based on an engagement state of a disconnector;
a second motor connected to a second drive wheel; and
a controller configured to:
control the engagement state of the disconnector based on required braking force before regenerative braking force generated by the second motor reaches an upper limit, while the second motor is performing regenerative braking, and
control, based on the engagement state of the disconnector, regenerative braking force of the first motor and the second motor.

2. The electrified vehicle according to claim 1, wherein the controller is configured to control the engagement state of the disconnector irrespective of the regenerative braking force generated by the second motor.

3. The electrified vehicle according to claim 1, wherein the controller is configured to, based on the required braking force being greater than the upper limit of the regenerative braking force by the second motor, control the disconnector to be engaged.

4. The electrified vehicle according to claim 1, wherein the controller is configured to, based on a rate of increase in the required braking force being greater than a predetermined value, control the disconnector to be engaged.

5. The electrified vehicle according to claim 1, wherein the controller is configured to, based on the disconnector being engaged, distribute the required braking force to the first motor and the second motor, and
wherein the required braking force is distributed to the second motor so that the regenerative braking force generated by the second motor reaches the upper limit.

6. The electrified vehicle according to claim 1, wherein the controller is configured to, based on the disconnector being engaged, control the required braking force to be supplied via hydraulic braking, the required braking force being greater than the regenerative braking force generated by the first motor and the second motor.

7. The electrified vehicle according to claim 1, wherein the second motor is configured to maintain a continuous connection with the second drive wheel.

8. A regenerative braking control method of an electrified vehicle including a first drive wheel connected to a first motor based on an engagement state of a disconnector and a second drive wheel connected to a second motor, the method comprising:
controlling the engagement state of the disconnector based on required braking force, while the second motor is performing regenerative braking; and
controlling regenerative braking force generated by the first motor and the second motor based on the engagement state of the disconnector.

9. The method according to claim 8, wherein controlling the engagement state of the disconnector is performed based on the required braking force, irrespective of whether an upper limit of the regenerative braking force generated by the second motor is reached or not.

10. The method according to claim 8, wherein controlling the engagement state of the disconnector comprises, based on the required braking force being greater than an upper limit of the regenerative braking force generated by the second motor, controlling the disconnector to be engaged.

11. The method according to claim 8, wherein controlling the engagement state of the disconnector comprises, based on a rate increase in the required braking force being greater than a predetermined value, controlling the disconnector to be engaged.

12. The method according to claim 8, wherein controlling the engagement state of the disconnector comprises distributing, based on the disconnector being engaged, the required braking force to the first motor and the second motor, and
wherein the required braking force is distributed to the second motor so that the regenerative braking force generated by the second motor reaches an upper limit.

13. The method according to claim 8, further comprising controlling, based on the disconnector being engaged, the required braking force to be supplied via hydraulic braking, the required braking force being greater than the regenerative braking force generated by the first motor and the second motor.

14. The method according to claim 8, wherein the second motor is configured to maintain a continuous connection with the second drive wheel.

15. A non-transitory computer-readable recording medium storing a program, wherein execution of the program causes one or more computers to perform operations comprising:
controlling an engagement state of a disconnector based on required braking force, while a second motor is performing regenerative braking; and
controlling regenerative braking force generated by a first motor and the second motor based on the engagement state of the disconnector.

16. The non-transitory computer-readable recording medium according to claim 15, wherein controlling the engagement state of the disconnector is performed based on the required braking force, irrespective of whether an upper limit of the regenerative braking force generated by the second motor is reached or not.

17. The non-transitory computer-readable recording medium according to claim 15, wherein controlling the engagement state of the disconnector comprises, based on the required braking force being greater than an upper limit of the regenerative braking force generated by the second motor, controlling the disconnector to be engaged.

18. The non-transitory computer-readable recording medium according to claim 15, wherein controlling the engagement state of the disconnector comprises, based on a rate increase in the required braking force being greater than a predetermined value, controlling the disconnector to be engaged.

19. The non-transitory computer-readable recording medium according to claim 15, wherein controlling the engagement state of the disconnector comprises distributing, based on the disconnector being engaged, the required braking force to the first motor and the second motor, and
wherein the required braking force is distributed to the second motor so that the regenerative braking force generated by the second motor reaches an upper limit.

20. The non-transitory computer-readable recording medium according to claim 15, wherein the operations further comprise controlling, based on the disconnector being engaged, the required braking force to be supplied via hydraulic braking, the required braking force being greater than the regenerative braking force generated by the first motor and the second motor.
